(19) United States
(12) Patent Application Publication
(10) Pub. No.: US 2009/0298190 A1
(43) Pub. Date: Dec. 3, 2009

(54) METHOD AND TEST DEVICE FOR DETECTING ORGANIC CORROSION INHIBITORS IN COOLANTS

(75) Inventors: Regis Joseph Pellet, Croton-on-Hudson, NY (US); Leonard S. Bartley, JR., Newburgh, NY (US); Paul O. Fritz, Newburgh, NY (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/129,322

(22) Filed: May 29, 2008

(51) Int. Cl. G01N 21/00; B01L 3/02

(52) U.S. Cl. 436/164; 422/100

(57) ABSTRACT

A test substrate for determining concentration of an organic corrosion inhibitor in a coolant fluid is provided. The test substrate comprises a porous substrate having at least a surface treated with a sufficient amount of at least a metal salt for reacting with a molar equivalent amount of the organic corrosion inhibitor in a representative sample of the coolant fluid, and at least a color indicator. The color indicator reacts with the metal salt and/or the organic corrosion inhibitor, forming an irreversibly colored complex and causing a color change in the test substrate.

### TECHNICAL FIELD

The invention relates generally to a test method for measuring corrosion inhibitor levels in coolants, and in one embodiment, a test device for the detection of organic corrosion inhibitors in coolants and the use of such test device.

### BACKGROUND

Cooling systems typically employ a variety of metals and metal alloys such as copper, brass, steel, cast iron, aluminum, magnesium, etc. Such metals and alloys can be vulnerable to corrosive attacks by various chemicals employed in the coolants, particularly under the condition of high temperatures and pressures typical of a cooling system. The presence of corroded parts in a cooling system can interfere with the heat transfer as well as performance of the engine components.

Corrosion inhibitors are commonly added to engine coolants, e.g., inorganic inhibitors such as silicates for aluminum protection and nitrites for cast iron protection; and organic inhibitors such as azoles for copper and brass protection, and carboxylic acids in the form of their salts for slower acting but longer life, affording a greater degree of protection than other types of inhibitors. All corrosion inhibitors employed in automotive antifreeze/coolant formulations are gradually depleted by use, with carboxylates being superior due to their slower depletion rate. The life expectancy of carboxylate containing coolants are typically five years or more.

Quick test methods are available for determining inorganic corrosion inhibitor contents, e.g., nitrite content, molybdate content, etc. of used engine coolant. With respect to organic corrosion inhibitors, US Patent Publication No. 2007/0138434, U.S. Pat. No. 5,744,365 and U.S. Pat. No. 5,952,233 disclose the use of a portable test kit for field use in determining the level of carboxylate anion in coolants, including a pipette or syringe for drawing coolant and at least a device to hold a volume of the coolant liquid and the indicator solution.

Analytical test substrates or matrixes employing various structures and materials have been widely used in the field of clinical chemistry, permitting the rapid, easy, and semi-quantitative determination of components in fluids. There is a need for convenient and easy method, such as the use of test substrates, in determining the level of organic corrosion inhibitors in coolants.

### SUMMARY OF THE INVENTION

In one aspect, there is provided a test substrate for determining the concentration of an organic corrosion inhibitor in a coolant fluid. The test substrate is treated with a sufficient amount of at least a metal salt for reacting with a molar equivalent amount of the organic corrosion inhibitor in a representative sample of the coolant fluid, and at least a color indicator for reacting with the metal salt and/or the organic corrosion inhibitor forming an irreversibly colored complex and causing a color change in the test substrate. When a representative sample of a coolant fluid is brought into contact with the treated surface of the porous substrate, the sufficient amount of metal salt reacts with the organic corrosion inhibitor in the representative sample forming an insoluble metal complex. Any unreacted metal salt and/or organic corrosion inhibitor reacts with the color indicator forming an irreversibly colored complex and departing a color change in the treated surface. The color change in the treated surface corresponds to a certain concentration of the organic corrosion inhibitor relative to a reference color chart.

In another aspect, there is provided a method for determining concentration of an organic corrosion inhibitor in a coolant fluid. The method comprises the steps of: providing a test substrate comprising a porous material, the porous substrate has at least a surface treated with a sufficient amount of at least a metal salt for reacting with a molar equivalent amount of the organic corrosion inhibitor in a representative sample of the coolant fluid, and at least a color indicator for reacting with the metal salt and/or the organic corrosion inhibitor forming an irreversibly colored complex and causing a color change in the test substrate; bringing a representative sample of the coolant fluid into contact with the treated surface of the porous substrate, wherein the sufficient amount of metal salt reacts with the organic corrosion inhibitor in the representative sample forming an insoluble metal complex, and wherein any unreacted metal salt and/or organic corrosion inhibitor reacts with the color indicator forming an irreversibly colored complex departing a color change in the treated surface; and observing any color change in the test substrate due to the reaction between the color indicator and the unreacted metal salt and/or organic corrosion inhibitor.

### BRIEF DESCRIPTION OF THE DRAWING

FIG. 1 is a top view of an embodiment of a single layer test substrate having at least one surface covered with a mixture of metal salt and color indicator.

FIG. 2 is a top view of an embodiment of a single layer test substrate having a single zone (area) treated with a mixture of metal salt and color indicator.

FIG. 3 is a perspective view of an embodiment of a single layer test substrate having a plurality of zones treated with metal salt and color indicator solutions.

FIG. 4 is a top view of an embodiment of a single layer test substrate with perforated lines separating a plurality of zones treated with the same metal salt and color indicator solution.

FIG. 5 is a top view of an embodiment of a single layer test substrate with a plurality of perforated lines separating a plurality of zones treated with different metal salt and color indicator solutions.

FIG. 6 is a perspective view of a composite single layer test substrate, with one side being treated with at least a metal salt and an opposite side being treated with at least a color indicator.

FIG. 7 is a perspective view of a composite single layer test substrate, with an intermediate mesh layer separating a side treated with at least a metal salt from the opposite side being treated with at least a color indicator.

FIG. 8 is a photograph capturing the appearance of test substrates from a series of test coolants are prepared by mixing varying amounts of commercially available coolants having different predetermined concentrations of organic corrosion inhibitors.

FIG. 9 is a photograph capturing the appearance of test substrates measuring the corrosion inhibitor levels from used coolants employed in a fleet of trucks.

FIGS. 10 and 11 are perspective views of embodiments of testing packets (booklets), each containing a plurality of test substrates.

### DETAILED DESCRIPTION

The following terms will be used throughout the specification and will have the following meanings unless otherwise indicated.

As used herein, the singular forms of nouns as well as the terms “a,” “an,” and “the,” include plural referents unless expressly and unequivocally limited to one referent.

The term “antifreeze” refers to a composition which reduces the freezing point of an aqueous solution, or is an aqueous solution with a reduced freezing point with respect to water, e.g., a composition comprising a freezing point depressant.

The term “coolant” refers generally to a heat transfer fluid. In one embodiment, the term coolant refers to a category of liquid antifreeze compositions which have properties that allow an engine to function effectively without freezing, boiling, or corrosion. The performance of an engine coolant must meet or exceed standards set by the American Society for Testing and Materials (A.S.T.M.) and the Society of Automotive Engineers (S.A.E.).

The term “heat transfer fluid” refers to a fluid which flows through a system in order to prevent its overheating, transferring the heat produced within the system to other systems or devices that can utilize or dissipate the heat.

The term “de-icing” fluid refers to a fluid which makes or keeps a system, a device, or a part free of ice, or a fluid which melts ice.

The term “color indicator,” or “colorimetric indicator,” or “indicator reagent” refers to a color reagent that leads to a color reaction from a colorless to a color, a color to colorless, or a first color to a second color.

As used herein, the term “coolants” or “coolant” composition (or fluid or concentrate) may be used interchangeably with “heat transfer,” “antifreeze,” or “de-icing” fluid (composition or concentrate).

As used herein, the term “test device” may be used interchangeably with “test strip,” “test substrate,” or “test matrix,” referring to a device comprising a porous substrate which absorbs the coolant to be measured for organic corrosion inhibitor levels.

It is believed that corrosion inhibitors, e.g, alkyl carboxylates, provide metal corrosion protection in coolant systems by forming a metal complex (or soap) on the metal components surface where potential corrosion may be imminent. These soaps are insoluble and form a protective barrier at the site of imminent corrosion and nowhere else, thus the corrosion inhibitors can protect aluminum, iron and other metal by this very localized insoluble soap formation. When a solution of metal cations is added to a coolant containing corrosion inhibitors, it forms a metal soap or complex which can be observed as an insoluble (or nearly insoluble in concentrations of less than 100 μg per liter of water, referred herein as “insoluble”) precipitate in solution.

If a sufficient level of corrosion inhibitors is present, all metal cations will be removed from solution by reacting with the corrosion inhibitors forming an insoluble precipitate. If the coolant is depleted of corrosion inhibitors (or the level is low), there will be a certain amount of free metal cations which can form a colored complex with a color indicator. This precipitate formation and more specifically, the ability of inhibitors to react irreversibly and quantitatively with metal cations is one of the bases for determining the content of/detecting the presence of corrosion inhibitors, and particularly organic corrosion inhibitors.

Corrosion Inhibitors: In one embodiment, the corrosion inhibitors are organic corrosion inhibitors, e.g., organic acids or soluble salts thereof, commonly used to improve corrosion inhibition properties of metals and metal alloys. Examples include azoles, which are typically used for copper and copper alloys; linear and branched aliphatic and aromatic organic acids (C₅-C₁₆) or alkali- or amino salt of linear and branched organic acids; aliphatic mono and di-acids (C₅-C₁₂), aromatic organic acids (C₇-C₁₈), or substituted aromatic organic acids (C₇-C₁₈) or ammonium, alkali- or amino salt of the foregoing acids; and mixtures thereof.

Specific examples of azoles include thiazoles and triazoles, for instance mercaptobenzothiazole, tolyltriazole, benzotriazole, 5-methylbenzotriazole, 2,5-dimercapto-1,3,4 thiadiazole (DMCT) and 1-pyrrolidine thiocarboic (1-PYRR) acid salts. Active azole levels typically used in corrosion inhibitor systems range from 0.1 to 15 parts, based upon the total weight of the coolant composition.

In one embodiment, the corrosion inhibitor is a salt of organic acidic compounds selected from salts of phosphorus acids, thiophosphorus acids, sulphur acids, carboxylic acids, thiocarboxylic acids, phenols, and the like. In another embodiment, the salts are neutral salts having a hydrocarbon chain, especially a non-aromatic hydrocarbyl chain, of at least 10 atoms.

In one embodiment, the corrosion inhibitor is an aliphatic mono acid (a C₅-C₁₂ aliphatic monobasic acid) or the alkali metal, ammonium, or amine salt thereof, e.g., ethylhexanoic, heptanoic, octanoic, nonanoic, decanoic, undecanoic and dodecanoic acids, and mixtures thereof. In another embodiment, the corrosion inhibitor to be detected is an alkali metal, ammonium, or amine salt of a monobasic acid.

In one embodiment, the organic corrosion inhibitor is selected from the group of aromatic organic acids and hydroxyl-substituted aromatic organic acids, including but not limited to benzoic acids, C₁-C₈-alkylbenzoic acids/salts thereof, for example o-, m- and p-methylbenzoic acid or p-tert-butylbenzoic acid, C₁-C₄-alkoxybenzoic acids, for example o-, m- and p-methoxybenzoic acid, hydroxyl-containing aromatic monocarboxylic acids, for example o-, m- or p-hydroxybenzoic acid, o-, m- and p-(hydroxymethyl)benzoic acid, a halobenzoic acids, for example o-, m- or p-fluorobenzoic acid. In one embodiment, the aromatic organic acid is selected from 2-hydroxybenzoic acid, p-terbutylbenzoic acid, mandelic acid and homophthalic acid and salts thereof.

In one embodiment, the corrosion inhibitor is selected from the group of carboxylic acids and salts thereof, e.g., alkali metal salts such as sodium or potassium salts, or as ammonium salts or substituted ammonium salts (amine salts), for example with ammonia, trialkylamines or trialkanolamines.

In one embodiment, the corrosion inhibitor is selected from the group of alkali metal or ammonium salts of carboxylic acids that form a water insoluble aluminum-carboxylate complex upon reaction with a source of aluminum cation. Examples of such alkali metal or ammonium salts include suberic acid, azelaic acid, undecanedioic acid, dodecanedioic acid, valeric acid, caproic acid, ethylhexanoic acid, octanoic acid, nonanoic acid, decanoic acid and undecanoic acid and their isomers, cyclohexane carboxylic acid, and the like. In another embodiment, the carboxylate corrosion inhibitor is an alkali metal ethylhexanoate, e.g., sodium ethylhexanoate, potassium ethylhexanoate, etc.

Soluble Metal Salt for Forming Insoluble Complex: The metal salt is chosen from those that form an insoluble or nearly insoluble complex with the corrosion inhibitors commonly used in coolants. Examples of metal salts that can be used in the test device include calcium (II), magnesium (II), zirconium (IV), aluminum (III), and chromium (III) salts such as calcium chloride (CaCl₂), calcium sulfate (CaSO₄), calcium nitrate (Ca(NO₃)2), magnesium chloride (MgCl₂), magnesium sulfate (MgSO₄), magnesium nitrate (Mg(NO₃)2), zirconium oxychloride (ZrOCl₂), zirconium nitrate (Zr(NO₃)4), zirconium sulfate (Zr(SO₄)2), zirconyl nitrate (ZrO(NO₃)2), aluminum sulfate (Al₂(SO₄)3), aluminum potassium sulfate (alum) (AlK(SO₄)2), aluminum nitrate (Al(NO₃)₃), chromium acetate (Cr(CH₃COO)₃), chromium nitrate (Cr(NO₃)3), chromium sulfate (Cr₂(SO₄)3), chromium oxalate (Cr₂(C₂O₄)3), copper sulfate (CuO₄S), and copper nitrate (Cu(NO₃)2.nH₂O).

In one embodiment wherein the corrosion inhibitor is selected from the group of alkali metal or ammonium salts of carboxylic acids, e.g., sodium ethylhexanoate, potassium ethylhexanoate, etc., the soluble metal is a soluble aluminum compound selected from the group of chlorides, sulfates, nitrates, etc., of aluminum and their hydrates. An example is aluminum nitrate nonahydrate, Al(NO₃)₃.9H₂O.

In one embodiment wherein the corrosion inhibitor is an aromatic carboxylate, the soluble metal salt is a soluble cobalt salt selected from the group of cobalt chloride, cobalt nitrate, and cobalt acetate.

The metal salt is employed in a sufficient amount, e.g., molar equivalent, to react with the desired concentration of organic corrosion inhibitors in the sample volume (e.g., a few drops or a quick dipping of an area of 2-6 cm² to get a coolant sample) forming an insoluble metal complex. In one embodiment, the metal salt is employed ranging from 1 to 5 times the molar equivalent of the amount needed to react with the desired concentration of the particular organic corrosion inhibitor employed in the coolant. In a second embodiment, this amount ranges from 1.1 to 2. In a third embodiment, the amount ranges from 1.05 to 1.5. In a fourth embodiment, the amount ranges from 2 to 4 times the molar equivalent amount.

Color Indicator: The color indicator comprises any material that will give a visual indication of the presence or absence of the corrosion inhibitor, or the presence or absence of the soluble metal salt, or the presence or absence of both corrosion inhibitor and the metal salt, by forming an irreversibly colored complex. In one embodiment, the visual indication is in the form of a spot pattern on the indicator bed, i.e., the indicator layer on the test substrate. The color change may be from colorless to a color, or it may be from a first color to a second color. The type of color indicators to be used and the concentration of color indicators for use in the test device can vary according to the type of engine coolant being tested, e.g., the type of corrosion inhibitors employed in the coolant and/or whether a coolant is dyed a certain color. Suitable color indicators that can be used to detect organic indicators such as carboxylic acids and salts are known to those skilled in the art, including but are not limited to hematoxylin, Eriochrome Cyanine R, aurintricarboxylic acid, Pantachrome Blue Black R, Alizarin S, and the like. In one embodiment with Fast Red TR salt as the color indicator reagent, the color indicator sample may undergo a change from colorless to yellow. Suitable color indicators for use in detecting the presence of metal ions (in the soluble metal salt) are known in the art, including 5-(4-dimethylaminobenzylidene)rhodanine for analysis of copper ions, and 2,4,6-tri(2-pyridinyl)-1,3,5-triazine (TPTZ) for detecting iron ions.

In one embodiment, the test substrate is impregnated with an indicator designed to detect the presence of organic corrosion inhibitors, e.g., a carboxylate, by generating distinctive precipitate or spot pattern on the indicator upon contact with excess corrosion inhibitors such as carboxylate. As used herein, “excess corrosion inhibitor” means that there is more than sufficient corrosion inhibitor to react with the soluble metal salt to form an insoluble metal complex. If the coolant to be tested still has sufficient corrosion inhibitors for protection (having “excess corrosion inhibitor”), then there is a color change in the indicator. The absence of a color change in the color indicator indicates that there is insufficient corrosion inhibitors in the coolant tested. As all corrosion inhibitors have reacted with the soluble metal salt, there is little if any left to react with the indicator to induce a color change. In one embodiment, spot detection of excess carboxylate anions is achieved with any of bromphenol blue, bromcresol green, and thymol blue indicator solutions.

In one embodiment, the color indicator applied onto the test substrate is a material that changes color when it is in contact with the soluble metal salt. If there is excess/left-over metal salt that did not react with the corrosion inhibitor, the excess metal salt induces a change in the color indicator. This color change indicates that there is insufficient corrosion inhibitors in the tested coolant.

In one embodiment with the use of aluminum for the soluble metal salt, the test substrate is impregnated with hematoxylin as the color indicator to produce clearly observable color changes when complexed with aluminum cations at an alkaline pH. In one embodiment of a test substrate employing hematoxylin, if the coolant does not contain a dye component, then the concentration of hematoxylin typically ranges from about 0.005 to about 2 mg per g coolant. It should be noted that one drop of water typically weighs about 50 mg. If the engine coolant contains a dye component, then the amount of color indicator can be increased due to the interference of the engine coolant dye component. In one embodiment for use with colored coolants, the amount of color indicator used for the test substrate ranges from about 0.2 to about 1 mg per g coolant and in a second embodiment, from about 0.4 to about 0.8 mg per g coolant.

Optional Components: Other components may be optionally included in the metal salt/color indicator solution(s). In one embodiment, a wetting agent is included to improved wetting of the test substrate. Illustrative examples include non-ionic surfactants, an-ionic surfactants, and the like. In another embodiment, the solution includes a stabilizing agent for preventing undesired degradation of the indicator and/or the metal salt. In one embodiment, the color indicator solution includes one or more organic or inorganic buffers for providing a suitable pH, which will not form an interfering complex with the tested coolant. Examples of buffers include borate buffers such as borax (sodium tetraborate). In another embodiment, the color indicator solution includes an additive for improved color development.

Test Device/Operation: In one embodiment, the test device is in the form of a substrate. In one embodiment and in addition to the substrate, the test device includes additional equipment and consumables for conducting the coolant test. In one embodiment, the device includes a gadget for obtaining a test sample of coolant, e.g., a pipette, an eye dropper, a stick, or syringe for drawing coolant. In one embodiment wherein the color indicator is hematoxylin or other indicator that produces color only at alkaline pH, the device further includes a quantity of material which can be used to adjust the pH of the coolant sample. In one embodiment, the test device further comprises a color guide to provide a semi-quantitative estimate of the amount of indicator present in the tested coolant. For example, distinct differences in color (change) intensity can be observed for ranges of inhibitor level or concentration.

The amount of metal salt to impregnate (apply onto) the test substrate is designed to be about molar equivalent to the concentration of carboxylate needed for adequate cooling system protection. When a predetermined amount of coolant sample comes into contact with the metal salt, corrosion inhibitors such as organic corrosion inhibitors, if any, will react with the metal salt to form an insoluble precipitate. The precipitate will be trapped within the pores of the test substrate. If an organic coolant inhibitor is present (in the coolant fluid phase) in excess of the predetermined amount that will react with the metal salt, this excess corrosion inhibitor will react with the color indicator inducing a color change. Depending on how the coolant is introduced onto the test substrate, the color change may be viewed as a dyed spot on test substrate if the coolant is applied as a drop onto the test substrate. If the inhibitor is present in less than the predetermined amount that will react with the metal salt, all corrosion inhibitor will be precipitated (as an insoluble complex form) and there is little left to react with the color indicator. In this embodiment, a passing coolant will generate a spot on the indicator strip whereas a failing coolant will not generate a spot.

In one embodiment of the testing process, a small quantity of used engine coolant is withdrawn from the cooling system to provide a representative sample whose organic corrosion inhibitor content is to be determined. A typical representative sample can be as little as a few droplets (or drops). The droplets can be picked up/withdrawn from the cooling system using any of a pasteur pipette, a medicine dropper (a tube with a suction bulb at the end), a syringe, a suction bottle, or a simple stick or tube for insertion into the coolants to be tested and which would hold/retain a few drops of liquid thereon. Depending on the method used to withdraw the coolant sample from the system, e.g., a medicine dropper or a syringe, each drop typically has a volume from about 0.010 to 0.10 ml, and with an average volume of 0.05 ml (20 drops equal 1 milimeter). The coolant sample is applied/dropped onto the test device, inducing a color change within a few seconds to thirty minutes, thus indicating whether there is a sufficient amount of corrosion inhibitors in the coolants or not. In one embodiment, the color change happens within 30 seconds to 5 minutes.

In one embodiment, the test device is in the form of a test substrate. In one embodiment and in addition to the test substrate, the test device further includes additional equipment and consumables for conducting the coolant test. Thus, in addition to the test substrate, the device may include such gadget for obtaining a test sample of coolant, e.g., a pipette, an eye dropper, or syringe for drawing coolant.

In one embodiment wherein the color indicator is hematoxylin or other indicator that produces color only at alkaline pH, the device further includes a quantity of material which can be used to adjust the pH of the coolant sample. In another embodiment, the test device further comprises a color guide to provide a semi-quantitative estimate of the amount of indicator present in the tested coolant. For example, distinct differences in color (change) intensity can be observed for ranges of inhibitor level. In yet another embodiment, the test device further comprises an inert support component for the test substrate. The inert support component can be any materials which give rigid support and do not interfere with the test reactants. For example, the support can be pressed, non-absorbing paper or cardboard, plastics of various types such as mylar, polyethylene, prolypropylene, and the like.

Embodiments of the Test Substrate: In one embodiment, the test substrate is in the form of a single layer having a single zone containing a combination of at least a soluble metal salt and a color indicator. In another embodiment, the test substrate is a single layer having multi-zones, with at least one zone for the soluble metal salt, and a second zone for the color indicator. In yet another embodiment, the device is in the form of a single test substrate as a composite layer comprising two adjacent substrates (or layers), one for the soluble metal salt and one for the color indicator. The soluble metal salt and the color indicator are applied separately (or together as a mixture) onto the test substrate by impregnation from solution and then dried, leaving behind the metal salt and/or the indicator compound. Further elaborations of the embodiments are as follows.

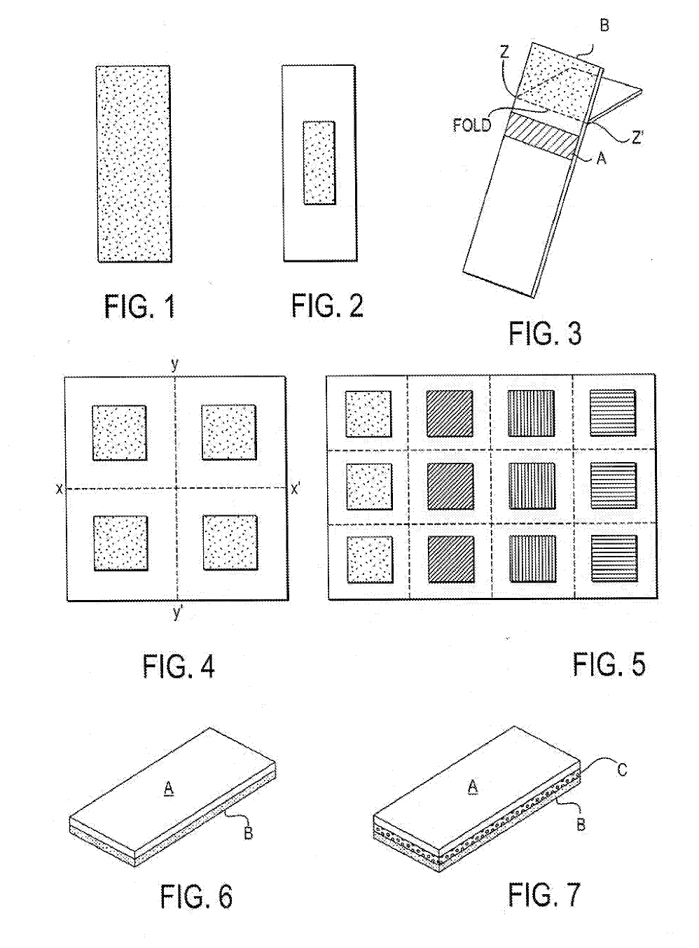

In one embodiment, the test device is in the form of a single layer test substrate having at least a surface area covered (“treated”) with a mixture of at least a soluble metal salt and at least a color indicator. The metal salt and color indicator have been selected such that there is a faster reaction between the organic corrosion inhibitor and the metal salt, than between the corrosion inhibitor and the color reagent. In one embodiment as illustrated in FIG. 1, the single test substrate is fully treated on at least one side with the metal salt/color indicator mixture. In another embodiment as illustrated in FIG. 2, the single test substrate contains a narrow zone A located at some distance from at least an edge (upper or lower edge) of the test substrate, containing the metal salt/color indicator mixture. In one embodiment, the treated zone A is located at least 1 cm away from the lower edge of the strip. When in use, several drops of the used coolant are applied onto the treated mixture of soluble salt and color indicator. In another embodiment, the test substrate is simply dipped into the coolant to be tested, taking care that the treated zone A stays above the surface of the coolant. After dipping, the coolant moves from the untreated area to the treated zone A by capillary action, which occurs as a result of the attraction of the coolant molecules to the paper. The change in the color of the treated zone A within a second to a few minutes indicates that there is sufficient organic corrosion inhibitor in the tested coolant, for the excess organic corrosion inhibitor (above the level sufficient to react with the metal salt in the treated zone) to induce a change in color in the treated zone. The color change can also be compared with a reference chart with different colors for a quantitative evaluation of the concentration of the organic corrosion inhibitor in the coolant.

In another embodiment as illustrated in FIG. 3, the test device is a single test substrate containing at least two zones. The first treated zone A containing the metal salt is located at some distance away from zone B, which is treated with a color indicator. In one embodiment, the treated zone A is at least 0.25 cm away from the color indicator zone B.

In one embodiment, the test trip is dipped into the coolant to be tested, for the coolant to move through the porous paper via capillary action. As the coolant containing the corrosion inhibitor rises through the paper to the treated zone A, it meets and reacts with the metal salt in the treated area A. Any excess corrosion inhibitor (above the amount needed to react with the metal salt in the treated zone A) moves to zone B and reacts with the color indicator, inducing a color change in the test substrate within a few seconds to a few minutes. If there is insufficient corrosion inhibitor in the tested coolant (all reacted with the metal salt in the treated zone A), there is no color change to be observed.

In one embodiment of a test substrate having a pre-fold line Z-Z′ as shown in FIG. 3, the test substrate is first folded along the folded line Z-Z′. Instead of dipping into a coolant solution, several drops of the used coolant are applied onto the treated zone A. The corrosion inhibitor in the coolant meets and reacts with the metal salt in the treated area A. Any excess corrosion inhibitor (above the amount needed to react with the metal salt in the treated zone A) flows through the paper into contact with the folded portion B pre-treated with a color indicator. If there is sufficient corrosion inhibitor in the coolant, the inhibitor induces a spot color change in the folded portion of the test substrate.

In one embodiment as illustrated in FIG. 4, the test device is a single test substrate containing a plurality of similarly treated zones, with each zone containing the same mixture of at least a soluble metal salt and/or at least a color indicator. In one embodiment, the single test substrate further comprises a plurality of perforated tear lines X-X′ and Y-Y′ separating the treated zones. The perforated lines allow the zones to be separated by folding and tearing along the perforated lines, generating multiple test substrates from a single sheet.

In one embodiment as shown in FIG. 5, the test device is a single test substrate containing a plurality of treated zones, with the zones contain different mixtures of soluble metal salts and color indicators. In one embodiment, the different mixtures comprise different metal salts and/or color indicators, with each mixture being tailored for the detection of particular organic corrosion inhibitors such as carboxylates, thiazoles, triazoles, etc. In yet another embodiment, the different mixtures comprise the same metal salts and/or color indicators, but at different concentrations to allow for the detection of different levels of organic corrosion inhibitors in the tested coolant. As illustrated, the test substrate may further comprise a plurality of perforated and/or pre-fold lines, which can be torn off generating multiple test substrates for testing different corrosion inhibitors to be generated from a single sheet.

In one embodiment as illustrated in FIG. 6, the test device is a composite test substrate containing two porous layers, e.g., paper substrates, in contact with each other. The first strip (herein referred to as the guard strip) A contains a metal salt selected for its ability to react quantitatively and irreversibly with an equivalent amount of corrosion inhibitor to form an insoluble complex. After drying, the solution leaves behind metal salt impregnated within the pore structure of the guard strip. The second strip (referred to as an indicator strip) B contains a colorimetric indicator that will give a visual indication when exposed to the organic corrosion inhibitor. The indicator is added by impregnation from solution and then dried to remove the impregnating media, leaving behind the indicator compound.

In one embodiment as illustrated in FIG. 7, a mesh layer C is in-between the guard strip A and the indicator strip B, facilitating the flow of the tested coolant to the color indicator bed. In one embodiment, the mesh layer can be in any form of a resin fabric (woven or unwoven), fiber, wools, silks, and the like, having open surface of holes ranging from 20 to 80% of total surface area.

The guard strip, the indicator strip, and the optional mesh layer can be attached in a variety of ways, e.g., using suitable contact cements or adhesives including hot sealable materials such as polyethylene, a fusion adhesive or a cold hardenable adhesive; heat sealing, and ultrasonic sealing, etc., as long as a coolant sample applied to the guard strip can flow to the second indicator strip. In one embodiment, a porous double-adhesive material is used to attach the strips. In yet another embodiment, contact cement is applied to various corners of the separate layers, allowing the formation of a composite strip without affecting the flow of coolants from the guard strip to the indicator strip (around the center area of the test substrate).

The material for use as the test substrate can be any porous material, e.g., paper, woven fiber or filament, etc. In one embodiment, the material is a smooth-textured paper low in organic and inorganic impurities, and having uniform physical characteristics. Examples include filter paper, chromatographic paper, and the like. In one embodiment, the paper is a commercial grade of cellulosic chromatographic paper especially manufactured for chromatography. Examples of suitable papers include Whatman thin layer chromatographic papers such as Whatman Nos. 2 to 4, and papers available from Ahlstrom such as Ahlstrom 238 Medium Thick Chromatography Paper (with a spec. of 0.35 mm-140 mm/30 min).

The test substrate size can vary depending on whether it is for single use or multiple uses (with perforated strips for splitting the strips), the type of the paper employed, the application type (dipping into a coolant to be tested, or applying coolant droplets onto the strip), the type of metal salt/color indicator to be employed (as separate mixtures/treatments, or as a single treatment of a mixture of metal salt and color indicator), etc. In one embodiment of a single use test substrate, the substrate has a surface area ranging from 4 cm² (2 cm by 2 cm square) to 5 cm² (1 cm by 4 cm rectangular strip).

As with the test substrate, the size of the treated zone containing the metal salt and/or color indicator varies according to a number of factors, including the type of paper employed, the application type (dipping or droplets), the corrosion inhibitor to be tested, the metal salt and/or color indicator treatment to be employed, etc. The treated zone can have a variety of sizes and shapes such as oval, oblong, round, square, rectangular, etc. In one embodiment, a mixture of metal salt/color indicator fully covers a test substrate having a surface area of 4-10 cm². In a second embodiment for a test substrate having a dimension of 2 cm by 10 cm, the treated zone is a narrow strip of ½ cm by 3 cm located in the center of the trip. In a third embodiment, the zone is circular in shape with a size corresponding to the spreading of a few drops of liquid, e.g., 1-2 cm.

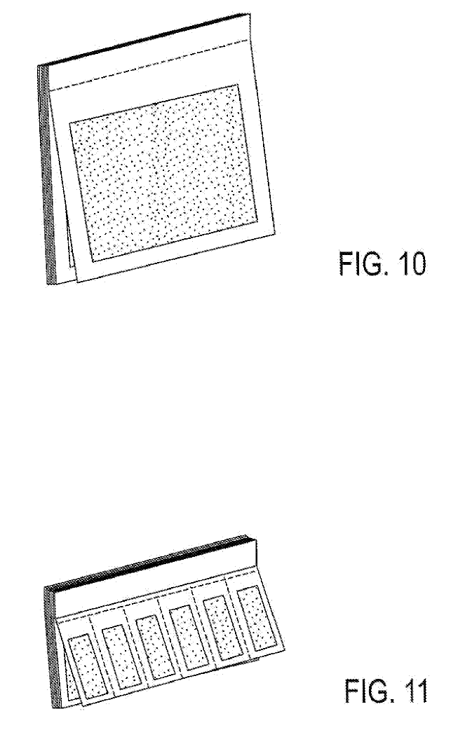

The test substrates can be commercialized as individual strips or pages. In one embodiment, the substrates are assembled into booklets or packets as shown in FIGS. 10 and 11. In FIG. 11, the substrates can be torn off along the perforated tear lines as individual strips.

It should be noted that factors such as dimensions of the test substrate, thickness of the paper, thickness of the soluble metal salt on the substrate, dimensions of the test zone, etc. are interdependent, and that any of these factors may be varied without departing from the original spirit of the invention.

### EXAMPLES

The following Examples are given as non-limitative illustration of aspects of the present invention.

### Example 1

### Guard Strip Preparation

An aluminum guard strip impregnating solution is prepared by dissolving 4.81 grams of aluminum nitrate nonahydrate in sufficient deionized water to yield 200.0 grams of solution. This is a 2.4% salt solution. Guard strips are prepared from Ahlstrom Chromatography, Electrophoresis and Blotting Paper, Grade 238 (15 cm×15 cm) sheets. Sheets are cut into 1″ (2.54 cm) wide strips that are 15 cm long. Guard strips are prepared by immersing the paper into the aluminum impregnating solutions until all pores are filled. The impregnated paper is then removed from the solution and drained to remove excess solution. Finally, the strips are placed on a stand to dry in a horizontal position in ambient air. Strips are dried so as to avoid or minimize pooling or gradient formation during the drying process. The aluminum content of the impregnation solution is determined empirically so that carboxylate inhibitor present in a coolant such as Texaco Extended Life AntiFreeze/Coolant™ (TELC) would be completely precipitated as aluminum carboxylate when TELC is at or below 70% of its recommended use level.

### Example 2

### Indicator Strip Preparation

The indicator solutions are prepared in two steps. In a first step, a pyrocatechol violet (PCV) stock solution is prepared by dissolving 0.200 grams of PCV in deionized water to yield 200.2 grams of stock solution. Next, 60.0 grams of this stock solution and 1.4055 grams of aluminum nitrate nonahydrate are dissolved in deionized water to yield 200.0 grams of indicator strip impregnating solution. Ahlstrom paper (grade 238) is cut into several 1″ (2.54 cm) by 15 cm paper strips and immersed in the impregnation solution until all pores are filled with solution. The paper is removed, drained and then allowed to dry overnight in a horizontal position to minimize pooling or gradient formation during the drying process. Indicator solution composition is determined empirically. A sufficient amount of PCV is added to the aluminum solution so that visual changes can be easily detected when the test substrate is exposed to carboxylate coolants such as TELC. If excess PCV is added, there may be possible interference due to the presence of other metals in the coolant.

### Example 3

### Composite Strip Formation

Dried guard strips and indicator strips prepared from Examples 1 and 2 are assembled into composite strips. The strips are prepared by applying a sufficient amount of contact cement to one side of the guard strip and one side of the indicator strip. The contact cement for use is 3M Photo Mount™ Spray Adhesive, applied in accordance with the manufacturer's instructions. Sufficient amount of contact cement means that enough is added so that intimate contact is made between strips without creating a barrier to coolant flow. The adhesive is allowed to dry at least one minute (but less than 5 minutes) before strips are brought into contact together. To assure proper adhesion, strips are firmly rolled together during the forming process. After the composite is formed, strips are ready for immediate use.

### Example 4

### Preparing Coolant Samples

A series of test coolants are prepared by mixing varying amounts of conventional coolant (“Conv. Coolant”) , pre-diluted 50/50 Texaco® Heavy Duty Phosphate Free coolant (“HDPF”), and pre-diluted 50/50 Texaco® Extended Life AntiFreeze/Coolant (“TELC”). Conventional coolant is a coolant having an additive package made up predominately of inorganic type compounds/corrosion inhibitors. HDPF is a conventional coolant, and as such its carboxylate content is very low. TELC is a heavy-duty coolant with an extended life organic corrosion inhibitor system.

When HDPF is added to TELC, the carboxylate level of the TELC mixture is reduced. The amount of carboxylate inhibition remaining is proportional to the amount of TELC in the mixture, with 100% TELC test coolant contains a full dose of the carboxylate, ethylhexanoate (EHA) at a dose of 1.6 wt % EHA (about 0.0113 moles of ethylhexanoate for every 100 grams of TELC). When the carboxylate inhibition level drops below 75%, there is insufficient carboxylate inhibition to assure the mixture's extended life properties and adequate carboxylate protection. Table 1 is a summary showing the concentration of the samples and their respective EHA contents.

TABLE 1

| | | % | | |
|---|---|---|---|---|
| Sample | % TELC | Conv. Coolant | % HDPF | Moles EHA per 100 g |
| F | 100 | 0 | 0 | 0.0113 |
| E | 80 | 20 | 0 | 0.0090 |
| D | 60 | 0 | 40 | 0.0068 |
| C | 40 | 60 | 0 | 0.0045 |
| B | 20 | 80 | 0 | 0.0023 |
| A | 0 | 0 | 0 | 0.000 |

### Example 5

### Testing the Composite Strips With Coolants

In this example, an indicator for an organic corrosion inhibitor such as carboxylate is synthesized by reacting a reactive metal, i.e., a solution of metal cations, with an indicator for that reactive metal. For example, aluminum cation reacts with pyrocatechol violet to form a soluble purple/violet complex. This complex reacts irreversibly with carboxylates to precipitate. The precipitate remains purple/violet but becomes trapped in the test substrate, will not migrate and can be detected as a violet purple spot when sufficient carboxylates break through the guardstrip to react with this indicator. If all carboxylates have been precipitated in the guardstrip, then carboxylate free coolant will enter the indicator strip and wash a spot free of the carboxylate indicator. Thus, if a spot is observed, then carboxlylates are detected.

Approximately 2 drops of each test coolant mixture were added to the guard strip side of the composite strip. In this example one 1 inch (2.54 cm) by 15 cm strip was used to evaluate all 6 test coolants. Coolants were added using a disposable pipette from Fisher Science Education, available as Fisherbrand™ Disposable Graduated Transfer Pipet (13-711-9 Series). The choice of pipette and the number of coolant drops are not considered critical to the ability of the composite test substrate to indicate carboxylate levels. The example is designed such that the total quantity of coolant added be completely adsorbed by the composite strip, and that excess coolant is not allowed to reach the indicator strip directly. Thus, the coolant does not flow pass the edges of the composite (onto the guardstrip), but rather must pass through the guard strip to reach the indicator strip. Accordingly, the coolant aliquots added to the guard strip soak into the bed and then pass through to the indicator bed where a pattern is generated. Sufficient time is permitted to allow all added coolant to be adsorbed by the guard bed and for the coolant phase to become visible on the indicator strip. Typically, this time is greater than one minute and less than 30 minutes.

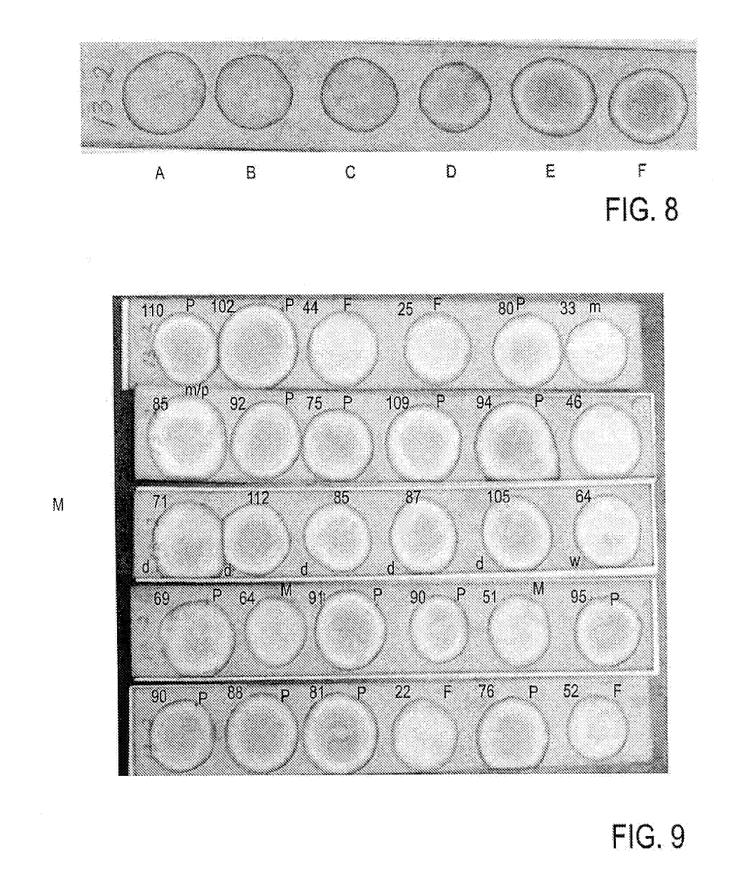

Test results from this example are captured in the photograph of FIG. 8 with the sample numbers A-F mapping into the % ELC concentration (or moles EHA per 100 g in the mixture) in Table 1. The photograph shows the indicator strip side of the composite, taken a short time (less than ½ hour) after the application of the coolant on the opposite guard side of the composite. Each coolant regardless of composition produces a circular wetting pattern. As shown, a darkened interior spot is seen in the circles for the 80 and 100% ELC liquid samples. Circles lacking the interior darkened spot are generated by the 0%, 20% and 40% ELC mixtures. The 60% sample is mottled and represents the pattern that occurs with a marginally inhibited ELC sample. It is noted that the composition at which the transition between the two patterns occurs can be controlled empirically by the metal content of the guard bed (aluminum in this case). With a lower aluminum content, the spot formation would be shifted to lower EHA content.

### Example 6

### Test Substrate Use With Field Samples

In this example, the accuracy of the test substrate in evaluating carboxylate levels in coolant samples is evaluated. Coolant samples are collected from a fleet of trucks that have been filled with TELC, and contaminated or diluted with water or with other non-carboxylate coolants. Coolant sample was taken from each of thirty trucks operating in over-the-road service, and each sample was analyzed by liquid chromatography to determine the amount of ethylhexanoate (“EHA”) present. Results are summarized in Table 2.

TABLE 2

| Coolant No. | % EHA | Strip Result* |
|---|---|---|
| 41829-10-10 | 110 | Pass |
| 41829-10-13 | 102 | Pass |
| 41829-12-22 | 44 | Fail |
| 41829-12-24 | 25 | Fail |
| 41829-12-25 | 80 | Pass |
| 41829-12-27 | 33 | Marginal |
| 41829-13-1 | 85 | Marginal |
| 41829-13-7 | 92 | Pass |
| 41829-13-10 | 75 | Pass |
| 41829-13-12 | 109 | Pass |
| 41829-13-13 | 94 | Pass |
| 41829-13-17 | 46 | Fail |
| 41829-13-19 | 71 | Pass |
| 41829-13-20 | 112 | Pass |
| 41829-15-13 | 85 | Pass |
| 41829-15-16 | 87 | Pass |
| 41829-15-18 | 105 | Pass |
| 41829-15-20 | 64 | Marginal |
| 41829-15-23 | 69 | Pass |
| 41829-15-24 | 64 | Marginal |
| 41829-15-25 | 91 | Pass |
| 41829-15-26 | 90 | Pass |
| 41829-15-27 | 51 | Marginal |
| 41829-15-28 | 95 | Pass |
| 41829-15-29 | 90 | Pass |
| 41829-16-22 | 88 | Pass |
| 41829-16-25 | 81 | Pass |
| 41829-16-27 | 22 | Fail |
| 41829-16-28 | 76 | Pass |
| 41829-17-2 | 52 | Fail |

*pass = spot, fail = no spot, marginal = mottled

Two to three drops of each coolant are added to the indicator side of strips prepared in the Examples above. Each coolant is allowed to permeate the test substrate penetrating to the indicator side of the substrate. The test substrate pattern is allowed to develop for at least 1 minute before recording test substrate results. A darkened zone within the wetted circular pattern is recorded as a pass. A circular pattern lacking this darkened zone is recorded as a fail. A mottled circular pattern is recorded as a marginal inhibitor (EHA) level. A quantitative analysis of the results shows that only one of the 30 coolant samples tested incorrectly. All samples with EHA levels below 70% are rated as marginal to fail. Al samples with EHA levels above 70% give passing indication with one exception.

FIG. 9 is a photograph capturing the appearance of the test substrates taken after several minutes elapsed time, and the strips had dried significantly. Each test spot is labelled with its corresponding EHA level (in Table 2) toward the upper left region of the spot. Even after considerable time had elapsed before this photo was taken, the correlation with spot pattern and coolant EHA content is apparent. A dark spot appears for all coolant with high, acceptable EHA content. An empty circle appears where EHA level is low. Mottled results are seen for lower EHA levels as well. The results show that the test substrate can be used as a reliable indicator of the corrosion inhibitor level in coolants.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. As used herein, the term “include” and its grammatical variants are intended to be non-limiting, such that recitation of items in a list is not to the exclusion of other like items that can be substituted or added to the listed items.

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for determining concentration of an organic corrosion inhibitor in a coolant fluid, the method comprising the steps of:
providing a test substrate comprising a porous material, the porous substrate has at least a surface treated with a sufficient amount of at least a metal salt for reacting with a molar equivalent amount of the organic corrosion inhibitor in a representative sample of the coolant fluid, and at least a color indicator for reacting with the metal salt and/or the organic corrosion inhibitor forming an irreversibly colored complex and causing a color change in the test substrate;
bringing a representative sample of the coolant fluid into contact with the treated surface of the porous substrate, wherein the sufficient amount of metal salt reacts with the organic corrosion inhibitor in the representative sample forming an insoluble metal complex, and wherein any unreacted metal salt and/or organic corrosion inhibitor reacts with the color indicator forming an irreversibly colored complex departing a color change in the treated surface;
observing any color change in the test substrate due to the reaction between the color indicator and the unreacted metal salt and/or organic corrosion inhibitor.

2. The method of claim 1, further comprising the step of comparing the color change in the substrate with a reference color chart for an evaluation of the concentration of the organic corrosion inhibitor in the coolant.

3. The method of claim 1, further comprising the step of obtaining a quantity of the coolant fluid as the representative sample of coolant having the organic corrosion inhibitor concentration to be determined using one of a pipette, an eye dropper, a stick, and a syringe, prior to bringing the representative sample into contact with the porous substrate.

4. The method of claim 1, wherein the test substrate comprises a first layer treated with the sufficient amount of metal salt and a second layer disposed adjacent to the first layer, the second layer being treated with the color indicator for reacting with the metal salt and/or the organic corrosion inhibitor, and wherein the color indicator color forms an irreversibly colored complex with any unreacted organic corrosion inhibitor in the coolant fluid flowing from the first layer to the second layer.

5. The method of claim 1, wherein the test substrate is a single sheet having a fold defining the first layer and the second layer, and when the single sheet is folded, unreacted organic corrosion inhibitor in the coolant fluid flowing from the first layer to the second layer and reacting with the color indicator in the second layer.

6. The method of claim 2, wherein the test substrate is a composite sheet and wherein the first layer and the second layer are joined by one of a contact cement, an adhesive, heat sealing, and ultrasonic sealing, forming the composite test substrate.

7. The method of claim 6, wherein the test substrate further comprises a mesh layer in-between the first layer and the second layer.

8. The method of claim 1, wherein the test substrate comprises least a surface area treated by a mixture comprising the sufficient amount of at least a metal salt and the color indicator.

9. The method of claim 8, wherein the test substrate is treated with a mixture comprising the sufficient amount of at least a metal salt and the color indicator.

10. The method of claim 1, wherein the test substrate comprises at least a first surface area treated by the sufficient amount of at least a metal salt and a second surface area treated by the color indicator.

11. The method of claim 1, wherein the test substrate comprises a plurality of zones defining a plurality of surface areas, each surface area is treated by a sufficient amount of at least a metal salt and a color indicator, and wherein the test substrate comprises a plurality of perforated lines for separating the plurality of surface areas.

12. The method of claim 11, wherein at least two different metal salts are used for treating the plurality of surface areas, each different metal salt is for forming a different insoluble metal complex with the corrosion inhibitor in the coolant.

13. The method of claim 1 1, wherein at least two different color indicators are used for treating the plurality of surface areas, each different color indicator is for forming a different discernible color change with the corrosion inhibitor in the coolant and/or the different metal salts.

14. A test device for determining concentration of an organic corrosion inhibitor in a coolant fluid, the device comprises a test substrate comprising a porous material, the porous substrate is treated with a sufficient amount of at least a metal salt for reacting with a molar equivalent amount of the organic corrosion inhibitor in a representative sample of the coolant fluid, and at least a color indicator for reacting with the metal salt and/or the organic corrosion inhibitor forming an irreversibly colored complex and causing a color change in the test substrate;
wherein after the representative sample of the coolant fluid is brought into contact with the treated surface of the porous substrate, the sufficient amount of metal salt reacts with the organic corrosion inhibitor in the representative sample forming an insoluble metal complex,
wherein any unreacted metal salt and/or organic corrosion inhibitor reacts with the color indicator forming an irreversibly colored complex and departing a color change in the treated surface, and
wherein the color change in the treated surface corresponds to a certain concentration of the organic corrosion inhibitor relative to a reference color chart.

15. The test device of claim 14, further comprising at least one of a pipette, an eye dropper, a stick, and a syringe, for obtaining the reference sample of the coolant fluid and for bringing the reference sample into contact with the treated surface.

16. The test device of claim 14, further comprising a reference color chart for quantitatively determining the concentration of the organic corrosion inhibitor in the coolant fluid.

17. The test device of claim 14, wherein the test substrate comprises a single sheet treated with a mixture of metal salt and color indicator.

18. The test device of claim 14, wherein the test substrate comprises a single sheet having at least two different surface areas, a first surface area treated with the sufficient amount of metal salt and a second surface area treated with the organic corrosion inhibitor.

19. The test device of claim 18, wherein the test substrate has a fold separating the two different surface areas, defining two separate layers, and when the substrate is folded, unreacted organic corrosion inhibitor in the coolant fluid flows from the first layer to the second layer reacting with the color indicator in the second layer.

20. The test device of claim 14, wherein the test substrate comprises a single sheet having a plurality of zones defining a plurality of surface areas, with each area being treated with the same mixture of metal salt and color indicator.

21. The test device of claim 14, wherein the test substrate comprises a single sheet having a plurality of zones defining a plurality of surface areas, with at least two areas being treated with different mixtures of metal salt and color indicator.

22. The test device of claim 21, wherein the test substrate further comprises a plurality of perforated lines separating the plurality of zones.

23. The test device of claim 14, wherein the test substrate comprises a single sheet having a plurality of zones defining a plurality of surface areas, with at least two areas being treated with two different metal salts for forming different insoluble metal complexes upon reacting with the organic corrosion inhibitor in the representative sample.

24. The test device of claim 14, wherein the test substrate comprises a composite sheet formed by joining a first layer and a second layer, the first layer is treated with the sufficient amount of metal salt and the second layer is treated with the color indicator for reacting with the metal salt and/or the organic corrosion inhibitor, and wherein the first layer and the second layer are joined by one of a contact cement, an adhesive, heat sealing, and ultrasonic sealing, forming the composite test substrate.

25. The test device of claim 14, wherein the color indicator in the substrate ranges from 0.005 to about 2 mg per g of coolant fluid.
